(19) United States
(12) Patent Application Publication
(10) Pub. No.: US 2026/0230864 A1
(43) Pub. Date: Aug. 6, 2026

(54) COMMUNICATION METHOD AND APPARATUS, AND STORAGE MEDIUM

(71) Applicant: Beijing Xiaomi Mobile Software Co., Ltd., Beijing (CN)

(72) Inventor: Jinhua WU, Beijing (CN)

(73) Assignee: Beijing Xiaomi Mobile Software Co., Ltd., Beijing (CN)

(21) Appl. No.: 19/142,827

(22) PCT Filed: Dec. 26, 2022
(86) PCT No.: PCT/CN2022/142081

§ 371 Date: Jun. 24, 2025

(51) Int. Cl. H04W 24/08

(52) U.S. Cl. CPC H04W 24/08

(57) ABSTRACT

A communication method includes: sending energy information related to energy of the terminal device, where the energy information indicates a second entity to determine communication status information of the terminal device according to the energy information.

### CROSS REFERENCE TO RELATED APPLICATIONS

The present application is a U.S. National Stage of International Application No. PCT/CN2022/142081, filed on Dec. 26, 2022, all contents of which are incorporated herein by reference in their entireties for all purposes.

### TECHNICAL FIELD

The present disclosure relates to the field of communication technologies, and in particular, to a communication method and apparatus, and a storage medium.

### BACKGROUND

Ambient power enabled Internet of Things (IoT) is an Internet of Things that supports ambient power. Power may be provided to the Internet of Things device by using energy from the environment in a particular usage scenario.

### SUMMARY

According to a first aspect of the embodiments of the present disclosure, there is provided a communication method, performed by a terminal device, and the method includes:
sending energy information related to energy of the terminal device, wherein the energy information is used to indicate a second entity to determine communication status information of the terminal device according to the energy information.

According to a second aspect of the embodiments of the present disclosure, there is provided a communication method, performed by a second entity, and the method includes:
receiving energy information related to energy of a terminal device;
determining communication status information of the terminal device according to the energy information; and
sending the communication status information.

According to a third aspect of the embodiments of the present disclosure, there is provided a communication apparatus, including:
a processor; and
a memory, configured for storing an instruction executable by the processor;
where, the processor is configured to perform the steps of the communication method provided in the first aspect of the present disclosure.

According to a fourth aspect of the embodiments of the present disclosure, there is provided a communication apparatus, including:
a processor; and
a memory, configured for storing an instruction executable by the processor;
where, the processor is configured to perform the steps of the communication method provided in the second aspect of the present disclosure.

According to a fifth aspect of the embodiments of the present disclosure, there is provided a non-transitory computer-readable storage medium, and a computer program instruction is stored on the computer-readable storage medium; when the computer program instruction is executed by a processor, the steps of the communication method provided in the first aspect of the present disclosure are implemented.

According to a sixth aspect of the embodiments of the present disclosure, there is provided a non-transitory computer-readable storage medium, and a computer program instruction is stored on the computer-readable storage medium; when the computer program instruction is executed by a processor, the steps of the communication method provided in the second aspect of the present disclosure are implemented.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of the description, illustrate embodiments consistent with the present disclosure and, together with the description, serve to explain the principles of the present disclosure.

FIG. 1 is a schematic diagram of a communication system shown according to some embodiments of the present disclosure.

FIG. 2 is a schematic diagram of a communication system shown according to some embodiments of the present disclosure.

FIG. 3 is a flowchart of a communication method shown according to some embodiments of the present disclosure.

FIG. 4 is a flowchart of a communication method shown according to some embodiments of the present disclosure.

FIG. 5 is a flowchart of a communication method shown according to some embodiments of the present disclosure.

FIG. 6 is a flowchart of a communication method shown according to some embodiments of the present disclosure.

FIG. 7 is a flowchart of a communication method shown according to some embodiments of the present disclosure.

FIG. 8 is a flowchart of a communication method shown according to some embodiments of the present disclosure.

FIG. 9 is a flowchart of a communication method shown according to some embodiments of the present disclosure.

FIG. 10 is a flowchart of a communication method shown according to some embodiments of the present disclosure.

FIG. 11 is a flowchart of a communication method shown according to some embodiments of the present disclosure.

FIG. 12 is a flowchart of a communication method shown according to some embodiments of the present disclosure.

FIG. 13 is a flowchart of a communication method shown according to some embodiments of the present disclosure.

FIG. 14 is a flowchart of a communication method shown according to some embodiments of the present disclosure.

FIG. 15 is a flowchart of a communication method shown according to some embodiments of the present disclosure.

FIG. 16 is a block diagram of a communication apparatus shown according to some embodiments of the present disclosure.

FIG. 17 is a block diagram of a communication apparatus shown according to some embodiments of the present disclosure.

FIG. 18 is a block diagram of a communication apparatus shown according to some embodiments of the present disclosure.

FIG. 19 is a block diagram of a communication apparatus shown according to some embodiments of the present disclosure.

### DETAILED DESCRIPTION

Example embodiments will be described in detail here, examples of which are illustrated in the accompanying drawings. The following description refers to the accompanying drawings in which the same numbers in different drawings represent the same or similar elements unless otherwise represented. The implementations described in the following example embodiments do not represent all implementations consistent with the present disclosure. By contrast, they are merely examples of apparatuses and methods consistent with some aspects of the present disclosure as detailed in the appended claims.

It should be noted that all actions for obtaining signals, information or data in the present disclosure are performed on the premise of conforming to the corresponding data protection regulation policy of the country of the location, and obtaining the authorization by the owner of the corresponding apparatus.

In the description of the present disclosure, terms such as “first” and “second” used in the present disclosure are used to distinguish between similar objects, and are not necessarily to be understood as a specific order or sequence. In addition, the same reference numbers in different drawings represent the same elements in the description of the drawings without the contrary.

In the description of the present disclosure, unless otherwise specified, “a plurality of” means two or more than two, and other quantifiers are similar. The terms “at least one”, “one or more” or the like, refers to any combination of them, including any combination of a single one or plural ones. For example, at least one may represent any number. For another example, one or more of a, b, and c may represent: a, b, c, a-b, a-c, b-c, or a-b-c, where a, b, and c may be singular or plural. “And/or” is an association relationship describing associated objects, indicating that there may be three relationships. For example, A and/or B may indicate three situations that A exists alone, both A and B exist, and B exists alone, where A and B may be singular or plural. The character “/” indicates an “or” relationship between the associated objects. The singular forms “a”, “an”, “one”, “the”, and “said” are intended to include the plural forms as well, unless the context clearly indicates other meanings.

Although the operations or steps are described in a specific order in the embodiments of the present disclosure or the accompanying drawings, it should not be understood that these operations or steps are required to be performed in the specific order or serial order shown, or all illustrated operations or steps are required to be performed to obtain a desired result. In the embodiments of the present disclosure, these operations or steps may be performed in any order without contradiction; these operations or steps may also be performed in parallel; some of these operations or steps may also be performed; or, the operations or steps in the plurality of embodiments or the accompanying drawings may also be combined arbitrarily, which is not limited in the present disclosure.

The implementation environment of the embodiments of the present disclosure are first described below.

The technical solutions of the embodiments of the present disclosure may be applied to various communication systems. The communication system may include one or more of the 4G (4 th Generation) communication system, the 5G (5 th Generation) communication system, and another future wireless communication system (for example, 6G). The communication system may also include one or more of a Public Land Mobile Network (PLMN) network, a Device-to-Device (D2D) communication system, a Machine to Machine (M2M) communication system, an Internet of Things (IoT), a Vehicle-to-Everything (V2X) communication system, or another communication system.

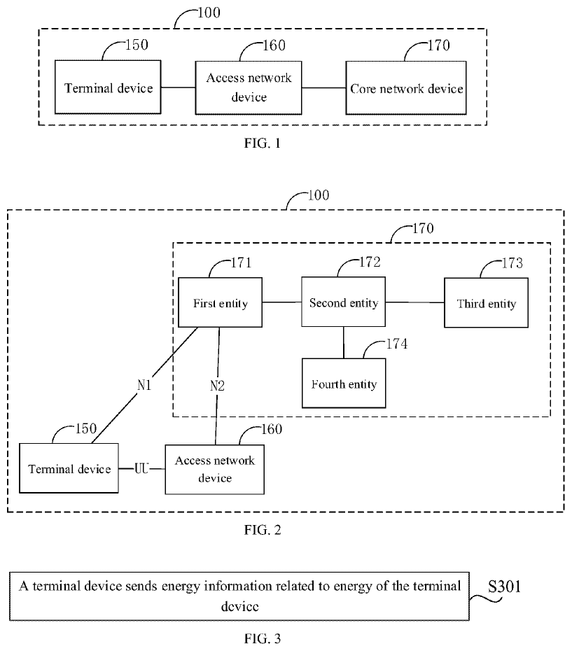

FIG. 1 is a schematic diagram of a communication system 100 shown according to some embodiments of the present disclosure. As shown in FIG. 1, the communication system 100 may include a terminal device 150, an access network device 160, and a core network device 170. The communication system may be configured to support a 4G network access technology, such as a Long Term Evolution (LTE) access technology, or a 5G network access technology, such as a New Radio Access Technology (New RAT), or another future wireless communication technology. The terminal device may be connected to the access network device in a wireless manner, and the access network device may be connected to the core network device in a wireless or wired manner. The core network device and the access network device may be independent different physical devices, or a function of the core network device may be integrated with a logical function of the access network device on the same physical device, or partial functions of the core network device and partial functions of the access network device are integrated on one physical device. It should be noted that, in the communication system, the number of the terminal device, the number of the access network device, and the number of the core network device may each be one or more; and, the number of the terminal device, the number of the access network device, and the number of the core network device of the communication system shown in FIG. 1 are merely adaptive examples, which is not limited in the present disclosure. Interconnections may be established between the terminal device and the terminal device, between the access network device and the access network device, or between the core network device and the core network device in a wired or wireless manner.

The terminal device in FIG. 1 may be an electronic device providing voice or data connectivity. For example, the terminal device may also be referred to as user equipment (UE), a subscriber unit, a mobile station, a station, a terminal, or the like. For example, the terminal device may include a smart phone, a smart wearable device, a smart speaker, a smart tablet, a modem, a wireless local loop (WLL) station, a personal digital assistant (PDA), customer premise equipment (CPE), or the like. With the development of wireless communication technologies, a device that may access a communication system, may communicate with an access network device of a communication system, or may communicate with another object by using a communication system, or a device that may directly communicate between two or more devices, may be the terminal device in the embodiments of the present disclosure, for example, a terminal or an automobile in intelligent transportation, a household device in smart home, a power meter reading instrument in a smart grid, a voltage monitoring instrument, an environment monitoring instrument, a video monitoring instrument in an intelligent security network, a cash register, or the like. In the embodiments of the present disclosure, the terminal device may communicate with the access network device, or the terminal device communicates with the core network device by using the access network device. Communication may also be performed between a plurality of terminal devices. The terminal device may be statically fixed or mobile, which is not limited in the present disclosure.

In some embodiments, the terminal device 150 may include an ambient power enabled Internet of Things device (Ambient IoT Device). The terminal device may be a mobile station, a tablet computer, or the like that can utilize ambient power, or may be a mobile terminal, a fixed terminal, or the like in various fields that can utilize ambient power. The specific form of the terminal device is not limited in the present disclosure.

In some embodiments, for an ambient power enabled Internet of Things device utilizing solar energy, normal communication may be performed by using solar energy on a sunny day; while in rainy days or evening, stored power may be used, or the device may be in dormant status in which only signaling/data is received or signaling/data is not sent or received. There may also be similar situations for an ambient power enabled Internet of Things device utilizing another ambient power. Thus, an ambient power enabled Internet of Things device may have no continuous power for response to always-on communication or on-demand communication.

The access network device in FIG. 1 may be configured to support access of the terminal device. For example, the access network device may be an evolutional NodeB (eNB or eNodeB) in LTE. The access network device may also be a next generation Node B (gNB, or gNodeB) in the 5G network. The access network device may also be a NG-radio access network (NG-RAN) device in the 5G network. The access network device may also be a base station, a broadband network gateway (BNG), a convergence switch, a non-3GPP (3rd Generation Partnership Project) access device, or the like in the future evolutional public land mobile network (PLMN). Optionally, the access network device in the embodiments of the present disclosure may include various forms of base stations, such as a macro base station, a micro base station (also referred to as a small station), a relay station, an access point, a 5G base station or a future base station, a satellite, a transmitting and receiving point (TRP), a transmitting point (TP), a mobile switch center, and a device that undertakes the function of a base station in Device-to-Device (D2D), machine-to-machine (M2M), Internet of Things (IoT), Vehicle-to-Machine (V2X) or other communication, etc., which is not specifically limited in the embodiments of the present disclosure. For ease of description, in all embodiments of the present disclosure, an apparatus that provides a wireless communication function for a terminal device is collectively referred to as an access network device or a base station.

The core network device in FIG. 1 may be configured to perform one or more of functions such as mobility management, call control, session management, registration authentication, and charging on the terminal device. The core network device may include one or more entities. The entity may be hardware, or may be software divided by functionality, or may be a structure combined by hardware and software. It should be noted that the entity may also be referred to as a function.

It should be noted that the access network device and the core network device may also be referred to as network devices. The network device in the present disclosure may include any function or entity in the access network device and the core network device.

FIG. 2 is a schematic diagram of another communication system 100 shown according to some embodiments of the present disclosure. As shown in FIG. 2, the core network device 170 in the communication system 100 may include a first entity 171 and a second entity 172, where the first entity 171 may be a function or an entity for performing access and mobility management on the terminal device. For example, the first entity may be an access and mobility management function (AMF). The second entity 172 may be a function or an entity for performing energy management on the terminal device. For example, the second entity may be an ambient Internet of Things power management function (AIPMF).

In some embodiments, the core network device 170 may further include a third entity 173, and the third entity may be a function or an entity for providing ambient information. For example, the third entity may be an application function (AF). In some embodiments, the ambient information may include weather information; and the AF may be an application function or an application server of a meteorological department, and may provide weather information.

It should be noted that the third entity 173 may be a function or an entity in the core network device, or may be a function or an entity except for the core network device, which is not limited in the present disclosure.

The second entity may be directly connected to the third entity, or may be connected to the third entity by using a network exposure function (NEF). For example, the second entity may perform message interaction with the third entity by using the NEF.

In some embodiments, the core network device 170 may further include a fourth entity 174, and the fourth entity may be a function or an entity for performing network data analysis. For example, the fourth entity may be a network data analytics function (NWDAF).

It should also be noted that the fourth entity 174 may be a function or an entity in the core network device, or may be a function or an entity except for the core network device, which is not limited in the present disclosure.

The second entity may be directly connected to the fourth entity, or may be connected to the fourth entity by using a network exposure function (NEF). For example, the second entity may perform message interaction with the fourth entity by using the NEF.

In some embodiments of the present disclosure, the core network device may further include one or more of a session management function (SMF), a unified data management (UDM), a user plane function (UPF), and a policy control function (PCF). For specific functions, connection relationships, and implementations of the AMF, the SMF, the UDM, the UPF, the NEF, and the PCF, reference may be made to related descriptions in related technologies (for example, the 3GPP protocol), and details are not described here again.

Due to the influence of ambient energy instability, sufficient power cannot be continuously provided for the Internet of Things device by using the ambient energy to support continuous wireless communication between the Internet of Things device and the mobile network. In order to overcome the above-mentioned problems in the related art, the present disclosure provides a communication method and apparatus, and a storage medium.

FIG. 3 is a flowchart of a communication method shown according to some embodiments of the present disclosure. The method may be applied to a terminal device in the foregoing communication system. As shown in FIG. 3, the method may include following step.

In S301, the terminal device sends energy information related to energy of the terminal device.

In some embodiments, the energy information is used to indicate a second entity to determine the communication status information of the terminal device according to the energy information.

The second entity may be a function or an entity for performing energy management on the terminal device; for example, the second entity may be an AIPMF.

In some embodiments, the terminal device may send the energy information to the second entity.

In some embodiments, the terminal device may send the energy information to a first entity, and the energy information may be used to indicate the first entity to send the energy information to the second entity.

For example, the terminal device may send the energy information to the first entity, or the terminal device may send the energy information to the first entity by using the access network device.

The first entity may be a function or an entity for performing access and mobility management on the terminal device; for example, the first entity may be an AMF.

In some embodiments, the energy information includes a power source indication parameter and/or an energy status parameter of the terminal device, and the energy information may also include other information related to energy of the terminal device.

The power source indication parameter may be used to indicate a power source of the terminal device. The power source of the terminal device may be at least one of solar energy, light energy, wind energy, motion energy/vibration energy, heat energy, and pressure energy, or any other power source.

The energy status parameter may be used to indicate current energy status of the terminal device.

In some embodiments, the energy status parameter may be a parameter of an enumeration type. For example, the energy status of the terminal device may include normal energy status, low energy status, or almost no energy status. The value of the energy status parameter may include a value indicating the three kinds of energy status. For example, if the value of the energy status parameter is 1, it may indicate that the energy status of the terminal device is normal energy status; if the value of the energy status parameter is 2, it may indicate that the energy status of the terminal device is low energy status; and if the value of the energy status parameter is 3, it may indicate that the energy status of the terminal device is almost no energy status.

In some embodiments, the energy status parameter may be any value between MIN and MAX, where MIN is used to represent a minimum value (for example, 0) of the remaining energy of the terminal device, and MAX may be used to represent a maximum value (for example, 1, 10, or 100) of the remaining energy of the terminal device.

In some embodiments, the energy information may be an energy management container, and the energy management container may include the power source indication parameter and/or the energy status parameter.

In some embodiments, the energy information may be used to indicate the second entity to determine the communication status information of the terminal device according to the energy information.

By using the foregoing method, the terminal device may send energy information related to energy of the terminal device, where the energy information may be used to indicate the second entity to determine the communication status information of the terminal device according to the energy information, so that the function of managing the communication status of the terminal device according to the energy information can be achieved, the ambient power enabled Internet of Things communication can be better supported, and effective response to continuous communication or on-demand communication can be achieved.

In some embodiments, the terminal device may send the energy information to the second entity by using a non-access stratum (NAS) message, or send the energy information to the first entity by using a non-access stratum (NAS) message.

It should be noted that the terminal device may send the NAS message to the access network device, and the access network device forwards the NAS message to the first entity or the second entity. The access network device may directly forward or transparently transmit the NAS message, or may send the location information of the terminal device to the first entity or the second entity when forwarding the NAS message, where the location information may include at least one of a cell identifier, a base station identifier, a location area identifier, an operator identifier, and longitude and latitude information.

In some embodiments, when forwarding the NAS message, the access network device may further send the location information of the terminal device to the first entity, where the location information may include at least one of a cell identifier, a base station identifier, a location area identifier, an operator identifier, and longitude and latitude information.

In some embodiments, the terminal device may send the energy information by using an access stratum (AS) message or a radio resource control (RRC) message. For example, the terminal device may send the energy information to the access network device by using an AS message or an RRC message, and the access network device may forward the energy information to the first entity by using a first message. Similarly, the access network device may also send the location information of the terminal device to the first entity.

In some embodiments, the terminal device may further include a terminal identification parameter in the NAS message, the AS message, or the RRC message, and the terminal identification parameter may be used to uniquely identify the terminal device. For example, the terminal identification parameter may include at least one of a subscription concealed identifier (SUCI), a subscriber permanent identifier (SUPI), a globally unique temporary identifier (GUTI), a permanent equipment identifier (PEI), an international mobile equipment identity (IMEI), an international mobile subscriber identity (IMSI), a temporary mobile subscriber identity (TMSI), or a radio network temporary identity (RNT). The GUTI may be a 5G-GUTI, or a 4G-GUTI, or a GUTI under another network standard, which is not limited in the present disclosure.

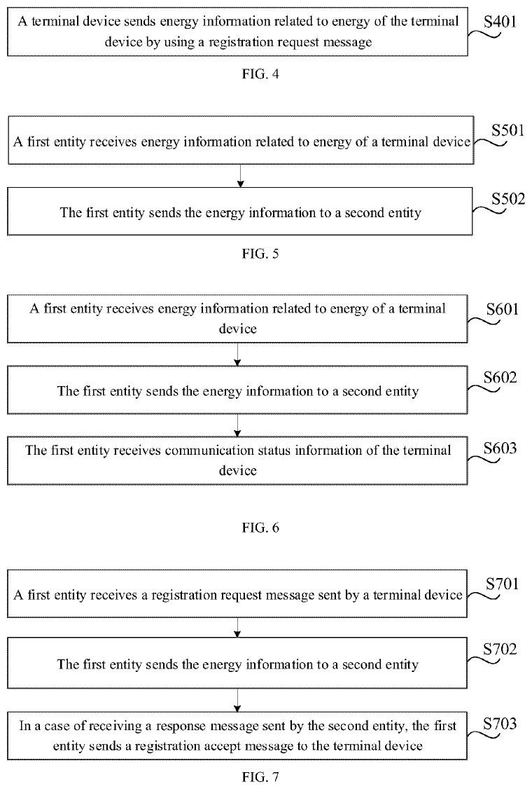

FIG. 4 is a flowchart of a communication method shown according to some embodiments of the present disclosure. The method may be applied to a terminal device. As shown in FIG. 4, the method may include the following step.

In S401, the terminal device sends energy information related to energy of the terminal device by using a registration request message.

For example, the terminal device may send a registration request message, and the registration request message may include the energy information related to the energy of the terminal device. The energy information may include a power source indication parameter and/or an energy status parameter of the terminal device.

It should be noted that, in the case of no contradiction, this embodiment may be combined with the foregoing embodiments or implementations and various optional solutions of the present disclosure. For the specific implementations of the foregoing steps in this embodiment, reference may also be made to the descriptions in the foregoing embodiments of the present disclosure, and details are not described here again.

In this way, the terminal device may send the energy information related to the energy of the terminal device by using the registration request message.

In some embodiments, after sending the registration request message, the terminal device may further receive a registration accept message.

For example, the terminal device may send the registration request message to the first entity, and then receive a registration accept message sent by the first entity in response to the registration request message.

In some embodiments, if the terminal device does not receive the registration accept message within a preset time after sending the registration request message, the terminal device may resend the registration request message, where the preset time may be any duration preset by the terminal device, for example, 1 second or 3 seconds. In this way, the reliability of message sending can be improved.

FIG. 5 is a flowchart of a communication method shown according to some embodiments of the present disclosure. The method may be applied to a first entity in the foregoing communication system. As shown in FIG. 5, the method may include following steps.

In S501, the first entity receives energy information related to energy of a terminal device.

In some embodiments, the energy information may be information sent by the terminal device to the first entity through an access network device.

In some embodiments, the energy information includes a power source indication parameter and/or an energy status parameter of the terminal device, and the energy information may also include other information related to energy of the terminal device. For a specific implementation of the power source indication parameter and the energy status parameter, reference may be made to the description of the foregoing embodiments of the present disclosure, and details are not described here again.

In S502, the first entity sends the energy information to a second entity.

In some embodiments, the energy information may be used to indicate the second entity to determine the communication status information of the terminal device according to the energy information.

In some embodiments, the first entity may be a function or an entity for performing access and mobility management on the terminal device, for example, the first entity may be an AMF. The second entity may be a function or an entity for performing energy management on the terminal device, for example, the second entity may be an AIPMF.

By adopting the foregoing method, the first entity receives the energy information related to the energy of the terminal device, and sends the energy information to the second entity, so that the function of managing the communication status of the terminal device according to the energy information can be achieved, the ambient power enabled Internet of Things communication can be better supported, and effective response to continuous communication or on-demand communication can be achieved.

In some embodiments, the first entity may receive the energy information sent by the terminal device by using a non-access stratum (NAS) message.

It should be noted that the terminal device may send the NAS message to the access network device, and the access network device forwards the NAS message to the first entity. The access network device may directly forward or transparently transmit the NAS message, or may send the location information of the terminal device to the first entity when forwarding the NAS message, where the location information may include at least one of a cell identifier, a base station identifier, a location area identifier, an operator identifier, and longitude and latitude information. In this way, the first entity may obtain the location information of the terminal device.

In some embodiments, the first entity may obtain the energy information by using a first message forwarded by the access network device. For example, the terminal device may send the energy information to the access network device by using an AS message or an RRC message, and the access network device may forward the energy information to the first entity by using the first message. Similarly, the access network device may also send the location information of the terminal device to the first entity. In this way, the first entity may obtain the location information of the terminal device.

In some embodiments, the first entity may further obtain the terminal identification parameter of the terminal device by using the NAS message or the first message. For a specific implementation of the terminal identification parameter, reference may be made to the description of the foregoing embodiments of the present disclosure, and details are not described here again.

In some embodiments, the first entity may further send the terminal identification parameter and/or location information of the terminal device to the second entity.

FIG. 6 is a flowchart of a communication method shown according to some embodiments of the present disclosure. As shown in FIG. 6, the method may include following steps.

In S601, a first entity receives energy information related to energy of a terminal device.

In S602, the first entity sends the energy information to a second entity.

For example, the first entity may send an energy management request message to the second entity, where the energy management request message may include the energy information.

In some embodiments, the energy management request message may further include the terminal identification parameter and/or location information of the terminal device.

In S603, the first entity receives communication status information of the terminal device.

In some embodiments, the communication status information may be status information determined by the second entity based on the energy information.

In some embodiments of the present disclosure, the communication status information may include a target communication status parameter, and the target communication status parameter is used to indicate the communication status of the terminal device. Different values of the target communication status parameter may correspond to different kinds of communication status.

For example, the communication status of the terminal device may include any one of normal status, receiver only status, and dormant status. The value of the target communication status parameter may include a value for indicating the three kinds of communication status. For example, if the value of the target communication status parameter is 1, it may indicate that the communication status of the terminal device is normal status; if the value of the target communication status parameter is 2, it may indicate that the communication status of the terminal device is receiver only status; and if the value of the target communication status parameter is 3, it may indicate that the communication status of the terminal device is dormant status.

In a case that the terminal device is in normal status, the terminal device may normally receive signaling and/or data sent by a network device (for example, an access network device or a core network device), or may normally send signaling and/or data to the network device.

In a case that the terminal device is in receiver only status, the terminal device may only receive signaling and/or data sent by the network device, and does not actively send signaling and data to the network device. In this status, the network device is expected to not receive signaling and data from the terminal device.

In a case that the terminal device is in dormant status, the terminal device cannot receive signaling and data sent by the network device, and cannot send signaling and/or data to the network device either. In this status, the network device cannot send signaling and data to the terminal device, and cannot receive signaling and data from the terminal device either.

In some embodiments of the present disclosure, the communication status information may include a target communication status parameter and a valid time parameter. The valid time parameter may be used to indicate a valid time range of the target communication status parameter.

In some embodiments, the valid time parameter may include a valid duration. The valid duration is used to indicate that the target communication status parameter starts to take effect from a moment when the target communication status parameter is sent or received, and becomes invalid after the valid duration.

In some embodiments, the valid time parameter may include a start moment and a valid duration. The target communication status may take effect from the start moment, and may become invalid after the valid duration.

In some embodiments, the valid time parameter may include a start moment and an end moment. The target communication status may take effect from the start moment, and may become invalid at the end moment.

In this way, the first entity may communicate with the terminal device according to the communication status information. For example, when the terminal device is in dormant status, the first entity may not send signaling or data to the terminal device, to improve communication reliability.

In some embodiments of the present disclosure, the first entity may further send the communication status information to the access network device, so that the access network device communicates with the terminal device according to the communication status information. For example, when the terminal device is in dormant status, the access network device may not send signaling or data to the terminal device, to improve communication reliability.

FIG. 7 is a flowchart of a communication method shown according to some embodiments of the present disclosure. As shown in FIG. 7, the method may include following steps.

In S701, a first entity receives a registration request message sent by a terminal device.

In some embodiments, the registration request message may include energy information related to energy of the terminal device. The energy information may include a power source indication parameter and/or an energy status parameter of the terminal device.

In S702, the first entity sends the energy information to a second entity.

In S703, in a case of receiving a response message sent by the second entity, the first entity sends a registration accept message to the terminal device.

In some embodiments, the response message may be used to indicate that the second entity receives the energy information.

It should be noted that, in the case of no contradiction, this embodiment may be combined with the foregoing embodiments or implementations and various optional solutions of the present disclosure. For specific implementations of the foregoing steps in this embodiment, reference may also be made to the descriptions in the foregoing embodiments of the present disclosure, and details are not described here again.

In this way, in the terminal registration process, the first entity may obtain the energy information of the terminal device, and forward the energy information to the second entity.

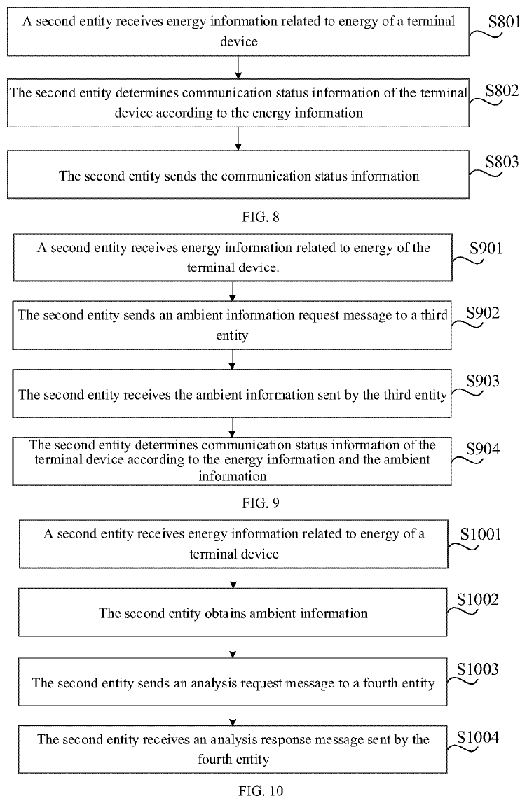

FIG. 8 is a flowchart of a communication method shown according to some embodiments of the present disclosure. The method may be applied to a second entity in the foregoing communication system. As shown in FIG. 8, the method may include following steps.

In S801, the second entity receives energy information related to energy of a terminal device.

In some embodiments, the second entity may be a function or an entity for performing energy management on the terminal device, for example, the second entity may be an AIPMF.

In some embodiments, the energy information includes a power source indication parameter and/or an energy status parameter of the terminal device, and the energy information may also include other information related to energy of the terminal device. For the specific implementation of the power source indication parameter and the energy status parameter, reference may be made to the description of the foregoing embodiments of the present disclosure, and details are not described here again.

In some embodiments, the second entity may receive the energy information sent by the terminal device.

In some embodiments, the second entity may receive the energy information sent by the first entity.

For example, the energy information may be sent by the terminal device to the first entity, and then forwarded by the first entity to the second entity.

The first entity may be a function or an entity for performing access and mobility management on the terminal device, for example, the first entity may be an AMF.

In S802, the second entity determines communication status information of the terminal device according to the energy information.

In some embodiments of the present disclosure, the communication status information may include a target communication status parameter, and the target communication status parameter is used to indicate the communication status of the terminal device. Different values of the target communication status parameter may correspond to different kinds of communication status.

For example, the communication status of the terminal device may include any one of normal status, receiver only status, and dormant status.

In some embodiments of the present disclosure, the communication status information may include a target communication status parameter and a valid time parameter, where the valid time parameter may be used to indicate a valid time range of the target communication status parameter.

It should be noted that, for the specific implementation of the target communication status parameter and the valid time parameter, reference may be made to the description in the foregoing embodiments of the present disclosure, and details are not described here again.

In S803, the second entity sends the communication status information.

For example, the second entity may send the communication status information to a target network device, where the target network device may include at least one entity of the access network device or the core network device, such as an AMF, an SMF, a UPF, a PCF, or the like. When receiving the communication status information, the target network device may store the communication status information of the terminal device, and process the communication of the terminal device according to the communication status information, so as to implement always-on communication or on-demand communication.

In some embodiments, the second entity may send the communication status information to the first entity. The first entity may further send the communication status information to the access network device.

By adopting the foregoing method, the second entity receives the energy information related to the energy of the terminal device, determines the communication status information of the terminal device according to the energy information, and sends the communication status information, so that the function of managing the communication status of the terminal device according to the energy information can be achieved, the ambient power enabled Internet of Things communication can be better supported, and effective response to continuous communication or on-demand communication can be achieved.

In some embodiments of the present disclosure, there may be a plurality of manners for determining the communication status information of the terminal device according to the energy information, and examples are as follows.

In some embodiments, the energy status of the terminal device may be determined according to the received energy information, and the communication status information may be determined according to the energy status.

For example, in a case that the energy status of the terminal device is normal energy status, it may be determined that the communication status of the terminal device is normal status, and the communication status information of the terminal device may be determined according to the communication status.

For another example, in a case that the energy status of the terminal device is low energy status, it may be determined that the communication status of the terminal device is receiver only status, and the communication status information may be determined according to the communication status.

For another example, in a case that the energy status of the terminal device is almost no energy status, it may be determined that the communication status of the terminal device is dormant status, and the communication status information is determined according to the communication status.

In some embodiments, the power source type and the energy status of the terminal device may be determined according to the received energy information, and the communication status information of the terminal device may be determined according to the power source type and the energy status.

For example, in a case that the power source type of the terminal device is an ambient power (for example, solar energy or wind energy) and the energy status parameter is low energy status, it may be determined that the communication status of the terminal device is receiver only status, and the communication status information may be determined according to the communication status.

For another example, in a case that the power source type of the terminal device is an ambient power (for example, solar energy or wind energy) and the energy status parameter is almost no energy status, it may be determined that the communication status of the terminal device is dormant status, and the communication status information may be determined according to the communication status.

In this way, the second entity determines the communication status information of the terminal device according to the energy information.

In some embodiments of the present disclosure, the second entity may further obtain the ambient information, and determine the communication status information of the terminal device according to the energy information and the ambient information.

In some embodiments, the second entity may determine a location area according to location information of the terminal device, and take weather information corresponding to the location area as the ambient information. For example, the location information may be a cell identifier or longitude and latitude, and the location area may include a city-level administrative area, a county-level administrative area, a village-level administrative area, or other areas where weather information may be obtained. The weather forecast information corresponding to the location area from the meteorological department may be obtained, so as to obtain the weather information corresponding to the location area.

In some embodiments, the weather information may include at least one of weather status, wind power level, wind direction, air pressure, humidity, precipitation quantity, air quality, or the like. Specifically, the weather status may be any one of sunny days, cloudy days, overcast days, rainy days, or snowy days.

In some embodiments, the second entity may send an ambient information request message to a third entity, and receive the ambient information sent by the third entity, where the third entity is a function or an entity for providing the ambient information.

For example, the third entity may be an AF providing the ambient information, for example, an application or an application server of the meteorological department. The second entity may send the ambient information request message to the third entity through the NEF, where the ambient information request message may also be referred to as an external information request message. The ambient information may be a response to external information, and the ambient information may include the weather information.

In some embodiments, the ambient information request message may include at least one of a location parameter, a time parameter, and an information type.

In some embodiments, the location parameter may be a parameter determined according to the location information of the terminal device. For example, a location area (for example, a city-level administrative area, a county-level administrative area, a village-level administrative area, or another area where weather information may be obtained) may be determined according to the location information (a cell ID or a location area) of the terminal device, and the location area is used as the location parameter.

The time parameter may be in units of hours, days, or weeks, such as one day, three days, five days, one week, or two weeks.

The information type may be used to indicate ambient information requested to be obtained, for example, predicted weather information.

In this way, weather information of a specific location area within a specific time may be obtained by using the ambient information request message.

In some embodiments, the second entity may perform data analysis according to the energy information and the ambient information to determine the communication status information. There may be a plurality of manners for performing data analysis according to the energy information and the ambient information, and examples are as follows.

In some embodiments, the power source type of the terminal device may be determined according to the energy information, and the communication status information of the terminal device may be determined according to the power source type and the weather information in the ambient information.

For example, in a case that the power source type is solar energy and the weather status in the weather information is a sunny day within the specified time, it may be determined that the communication status of the terminal device is normal status.

For another example, in a case that the power source type is solar energy and the weather status in the weather information is a non-sunny day within the specified time (for example, a cloudy day, a rainy day, or a snowy day), it may be determined that the communication status of the terminal device is receiver only status.

In some embodiments, the energy status of the terminal device may be determined according to the energy information, and the communication status information of the terminal device may be determined according to the energy status and the weather information in the ambient information.

For example, in a case that the energy status is normal status and the weather status in the weather information is a non-sunny day (for example, a cloudy day, a rainy day, or a snowy day) within the specified time, it may be determined that the communication status of the terminal device is receiver only status.

For another example, in a case that the energy status is receiver only status and the weather status in the weather information is a sunny day within the specified time, it may be determined that the communication status of the terminal device is normal status.

In some embodiments, the power source type and the energy status of the terminal device may be determined according to the energy information, and the communication status information of the terminal device may be determined according to the power source type, the energy status, and the weather information.

For example, in a case that the power source type is solar energy, the communication status information of the terminal device may be determined according to the weather status in the weather information.

In some embodiments, in a case that the energy status of the terminal device is normal energy status and the weather status is a sunny day within the specified time, it may be determined that the communication status of the terminal device is normal status. In the normal status, the terminal device may normally receive signaling and/or data sent by the target network device, or may normally send signaling and/or data to the target network device, where the target network device may include at least one entity of the access network device or the core network device.

In some embodiments, in a case that the energy status of the terminal device is low energy status and the weather status is a non-sunny day (for example, a cloudy day, a rainy day, or a snowy day) within the specified time, it may be determined that the communication status of the terminal device is receiver only status. In the receiver only status, the terminal device may receive signaling and/or data sent by the target network device, but does not send signaling and data to the target network device.

In some embodiments, in a case that the energy status of the terminal device is almost no energy status, and the weather status is a non-sunny day (for example, a cloudy day, a rainy day, or a snowy day) within the specified time, it may be determined that the communication status of the terminal device is dormant status. In the dormant status, the terminal device does not receive signaling and data sent by the target network device, and does not send signaling and data to the target network device either.

In some embodiments, the specified time may be any preset time information, and the specified time may be used as the valid time information in the communication status information.

In a case that the power source type is wind energy, the communication status information of the terminal device may be determined according to the wind power level in the weather information.

In some embodiments, in a case that the energy status of the terminal device is normal energy status and the wind power level is greater than or equal to a first preset level within the specified time, it may be determined that the communication status of the terminal device is normal status.

In some embodiments, in a case that the energy status of the terminal device is low energy status and the wind power level is less than or equal to a second preset level within the specified time, it may be determined that the communication status of the terminal device is receiver only status. The second preset level may be less than the first preset level.

In some embodiments, in a case that the energy status of the terminal device is almost no energy status and the wind power level is less than or equal to the second preset level within the specified time, it may be determined that the communication status of the terminal device is dormant status.

In some embodiments, the specified time may be any preset time information, and the specified time may be used as the valid time information in the communication status information.

In this way, the second entity may determine the communication status information of the terminal device in any one of the foregoing manners.

FIG. 9 is a flowchart of a communication method shown according to some embodiments of the present disclosure. As shown in FIG. 9, the method may include following steps.

In S901, a second entity receives energy information related to energy of the terminal device.

In S902, the second entity sends an ambient information request message to a third entity.

In some embodiments, the third entity may be a function or an entity for providing ambient information.

In S903, the second entity receives the ambient information sent by the third entity.

In S904, the second entity determines communication status information of the terminal device according to the energy information and the ambient information.

It should be noted that, in the case of no contradiction, this embodiment may be combined with the foregoing embodiments or implementations and various optional solutions of the present disclosure. For the specific implementations of the foregoing steps in this embodiment, reference may also be made to the descriptions in the foregoing embodiments of the present disclosure, and details are not described here again.

By adopting the foregoing manner, the second entity may determine the communication status information of the terminal device.

FIG. 10 is a flowchart of a communication method shown according to some embodiments of the present disclosure. As shown in FIG. 10, the method may include following steps.

In S1001, a second entity receives energy information related to energy of a terminal device.

In S1002, the second entity obtains ambient information.

In S1003, the second entity sends an analysis request message to a fourth entity.

In some embodiments, the analysis request message may include energy information and ambient information, and the fourth entity is a function or an entity for performing network data analysis.

In some embodiments, the fourth entity may determine the communication status information by performing data analysis according to the energy information and the ambient information. In some embodiments, for the manner of performing data analysis according to the energy information and the ambient information, reference may be made to the description in the foregoing embodiments of the present disclosure, and details are not described here again.

In S1004, the second entity receives an analysis response message sent by the fourth entity.

In some embodiments, the analysis response message may include communication status information of the terminal device.

It should be noted that, in the case of no contradiction, this embodiment may be combined with the foregoing embodiments or implementations and various optional solutions of the present disclosure. For the specific implementations of the foregoing steps in this embodiment, reference may also be made to the descriptions in the foregoing embodiments of the present disclosure, and details are not described here again.

By adopting the foregoing manner, the second entity may determine the communication status information of the terminal device.

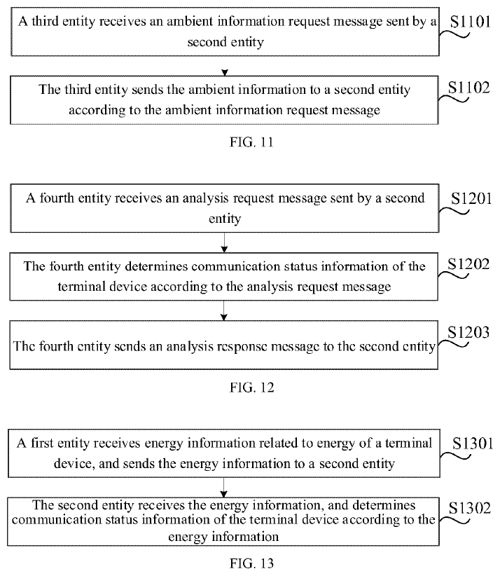

FIG. 11 is a flowchart of a communication method shown according to some embodiments of the present disclosure. The method may be applied to a third entity in the foregoing communication system. As shown in FIG. 11, the method may include following steps.

In S1101, a third entity receives an ambient information request message sent by a second entity.

In some embodiments, the third entity may be a function or an entity for providing ambient information.

In S1102, the third entity sends the ambient information to a second entity according to the ambient information request message.

In some embodiments, the ambient information may be used to indicate the second entity to determine the communication status information of the terminal device according to the energy information and the ambient information.

It should be noted that, in the case of no contradiction, this embodiment may be combined with the foregoing embodiments or implementations and various optional solutions of the present disclosure. For the specific implementations of the foregoing steps in this embodiment, reference may also be made to the descriptions in the foregoing embodiments of the present disclosure, and details are not described here again.

By adopting the foregoing manner, the third entity may provide the ambient information to the second entity.

In some embodiments, the second entity may be a function or an entity for performing energy management on the terminal device, for example, the second entity may be an AIPMF.

In some embodiments, the third entity may be a function or entity for providing ambient information. For example, the third entity may be an AF. In some embodiments, the ambient information may include weather information, and the AF may be an application function or an application server of the meteorological department, and may provide weather information.

FIG. 12 is a flowchart of a communication method shown according to some embodiments of the present disclosure. The method may be applied to a fourth entity in the foregoing communication system. As shown in FIG. 12, the method may include following steps.

In S1201, a fourth entity receives an analysis request message sent by a second entity.

In some embodiments, the analysis request message may include energy information and ambient information, and the fourth entity is a function or an entity for performing network data analysis.

In S1202, the fourth entity determines communication status information of the terminal device according to the analysis request message.

In some embodiments, the fourth entity may determine the communication status information by performing data analysis according to the energy information and the ambient information. For the manner of performing data analysis according to the energy information and the ambient information, reference may be made to the description in the foregoing embodiments of the present disclosure, and details are not described here again.

In S1203, the fourth entity sends an analysis response message to the second entity.

In some embodiments, the analysis response message may include communication status information of the terminal device.

It should be noted that, in the case of no contradiction, this embodiment may be combined with the foregoing embodiments or implementations and various optional solutions of the present disclosure. For the specific implementations of the foregoing steps in this embodiment, reference may be made to the descriptions in the foregoing embodiments of the present disclosure, and details are not described here again.

By adopting the foregoing manner, the fourth entity may determine the communication status information of the terminal device, and send the communication status information to the second entity.

In some embodiments, the second entity may be a function or an entity for performing energy management on the terminal device, for example, the second entity may be an AIPMF.

In some embodiments, the fourth entity may be a function or an entity for performing network data analysis, for example, the fourth entity may be a NWDAF.

FIG. 13 is a flowchart of a communication method shown according to some embodiments of the present disclosure. The method may be applied to a communication device, and the communication device may include a first entity and a second entity in the foregoing communication system. As shown in FIG. 13, the method may include following steps.

In S1301, a first entity receives energy information related to energy of a terminal device, and sends the energy information to a second entity.

In S1302, the second entity receives the energy information, and determines communication status information of the terminal device according to the energy information.

It should be noted that, in the case of no contradiction, this embodiment may be combined with the foregoing embodiments or implementations and various optional solutions of the present disclosure. For the specific implementations of the foregoing steps in this embodiment, reference may also be made to the descriptions in the foregoing embodiments of the present disclosure, and details are not described here again.

By adopting the foregoing manner, the communication device may determine the communication status information of the terminal device according to the energy information.

In some embodiments, the communication device may further include a third entity, and the third entity is an entity configured to store ambient information. The method may further include:
the second entity sends an ambient information request message to the third entity, receives the ambient information sent by the third entity, and determines the communication status information of the terminal device according to the energy information and the ambient information; and
the third entity sends the ambient information to the second entity according to the received ambient information request message.

In some embodiments, the communication device further includes a fourth entity, and the fourth entity is a functional entity for performing network data analysis. The method may further include:
the second entity sends an analysis request message to the fourth entity, and receives an analysis response message sent by the fourth entity; the analysis request message includes energy information and ambient information, and the analysis response message includes communication status information of the terminal device; and
the fourth entity receives the analysis request message, and determines the communication status information according to the energy information and the ambient information in the analysis request message.

In some embodiments, the first entity may be a function or an entity for performing access and mobility management on the terminal device, for example, the first entity may be an AMF.

In some embodiments, the second entity may be a function or an entity for performing energy management on the terminal device, for example, the second entity may be an AIPMF.

In some embodiments, the third entity may be a function or entity for providing ambient information. For example, the third entity may be an AF. In some embodiments, the ambient information may include weather information, and the AF may be an application function or an application server of the meteorological department, and may provide weather information.

In some embodiments, the fourth entity may be a function or an entity for performing network data analysis, for example, the fourth entity may be a NWDAF.

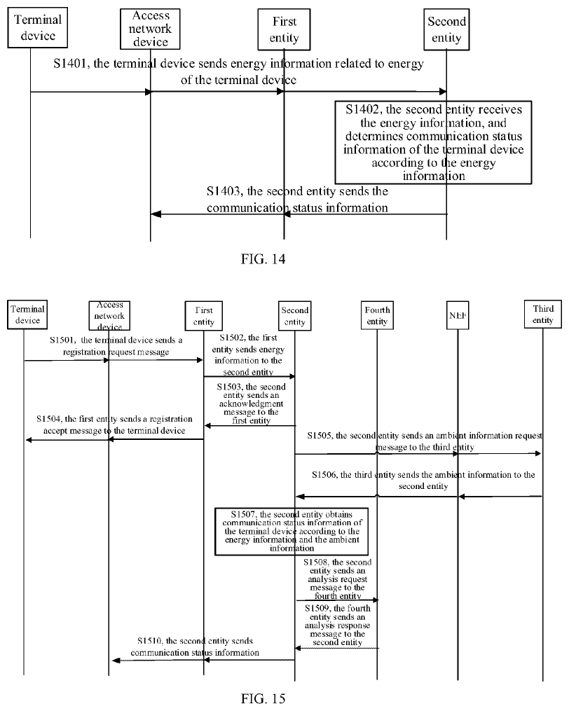

FIG. 14 is a flowchart of a communication method shown according to some embodiments of the present disclosure. As shown in FIG. 14, the method may include following steps.

In S1401, a terminal device sends energy information related to energy of the terminal device.

In some embodiments, the terminal device may directly send the energy information to a second entity.

In some embodiments, the terminal device may send the energy information to the second entity by using a first entity.

In S1402, the second entity receives the energy information, and determines communication status information of the terminal device according to the energy information.

In S1403, the second entity sends the communication status information.

It should be noted that, in the case of no contradiction, this embodiment may be combined with the foregoing embodiments or implementations and various optional solutions of the present disclosure. For the specific implementations of the foregoing steps in this embodiment, reference may also be made to the descriptions in the foregoing embodiments of the present disclosure, and details are not described here again.

By adopting the foregoing manner, the function of managing the communication status of the terminal device according to the energy information can be achieved, the ambient power enabled Internet of Things communication can be better supported, and effective response to continuous communication or on-demand communication can be achieved.

FIG. 15 is a flowchart of a communication method shown according to some embodiments of the present disclosure. As shown in FIG. 15, the method may include following steps.

In S1501, a terminal device sends a registration request message.

In some embodiments, the registration request message may include energy information of the terminal device, the energy information may also be referred to as an energy management container, and the energy management container may include a power source indication parameter and/or an energy status parameter, or may include other information related to energy of the terminal device.

In some embodiments, the terminal device may send the registration request message to a first entity by using an access network device. The access network device may send the cell identifier where the terminal device is located with the registration request message to the first entity. The registration request message may be a NAS message.

In S1502, the first entity sends energy information to a second entity.

In some embodiments, the first entity may further send the terminal identifier and the location information of the terminal device to the second entity, where the location information may be a cell identifier where the terminal device is located.

In S1503, the second entity sends an acknowledgment message to the first entity.

In S1504, the first entity sends a registration accept message to the terminal device.

For example, the first entity may send the registration accept message to the terminal device by using the access network device.

In S1505, the second entity sends an ambient information request message to a third entity.

The ambient information request message may also be referred to as an external information request message.

For example, based on the foregoing energy information, the second entity may send, to the third entity through the NEF, an external information request including a location (a geographic location) of the terminal device, a time (day or week), and an information type (weather prediction).

In some embodiments, the second entity may obtain the foregoing location based on the cell ID mapping. The time and the information type described above may be weather predictions in the future time. The third entity may be an AF, or a meteorological department/application.

In S1506, the third entity sends the ambient information to the second entity.

For example, the third entity may send the ambient information to the second entity by using the NEF, where the ambient information may also be referred to as external information, and the ambient information may include weather forecast (sunny, rainy, cloudy, or snowy, etc.) and a valid time (day or week).

In S1507, the second entity obtains communication status information of the terminal device according to the energy information and the ambient information.

In some embodiments, the second entity may perform data analysis and obtain communication status information of the terminal device, where the data analysis may be data analysis and prediction on the communication status of the ambient Internet of Things device, and the communication status information may include communication status (normal status, receiver only status, and dormant status) having a valid time.

In S1508, the second entity sends an analysis request message to a fourth entity.

In some embodiments, the analysis request message may include energy information and ambient information, and the fourth entity is a function or an entity for performing network data analysis.

In some embodiments, the fourth entity may determine the communication status information by performing data analysis according to the energy information and the ambient information. In some embodiments, for the manner of performing data analysis according to the energy information and the ambient information, reference may be made to the description in the foregoing embodiments of the present disclosure, and details are not described here again.

In S1509, the fourth entity sends an analysis response message to the second entity.

In some embodiments, the analysis response message may include communication status information of the terminal device.

It should be noted that in the case of performing S1507, S1508 and S1509 may not be performed. Alternatively, in the case of performing S1508 and 1509, S1507 may not be performed.

In S1510, the second entity sends communication status information.

In some embodiments, the second entity may send communication status information to the first entity, and the first entity sends the communication status information to the access network device.

In some embodiments, the second entity may send a communication notify to the first entity and the access network device, and the communication notify may include the terminal identifier of the terminal device and the communication status information. The communication status information may be communication status (normal status, receiver only status, dormant status) with a valid time.

In some embodiments, the first entity and the access network device may store the communication status information in the UE context corresponding to the terminal identifier, and correspondingly process the communication of the terminal device according to the communication status information.

It should be noted that, in the case of no contradiction, this embodiment may be combined with the foregoing embodiments or implementations and various optional solutions of the present disclosure. For the specific implementations of the foregoing steps in this embodiment, reference may also be made to the descriptions in the foregoing embodiments of the present disclosure, and details are not described here again.

By adopting the foregoing manner, the function of managing the communication status of the terminal device according to the energy information can be achieved, the ambient power enabled Internet of Things communication can be better supported, and effective response to continuous communication or on-demand communication can be achieved.

In some embodiments of the present disclosure, there is provided a communication device, and the communication device may include a first entity and a second entity, where:
the first entity is configured to receive energy information related to the energy of the terminal device and send the energy information to the second entity; and
the second entity is configured to receive the energy information, and determine communication status information of the terminal device according to the energy information.

In some embodiments, the first entity may be configured to perform the steps of the communication method related to the first entity in the foregoing embodiments of the present disclosure; and the second entity may be configured to perform the steps of the communication method related to the second entity in the foregoing embodiments of the present disclosure.

In some embodiments, the first entity may be a function or an entity for performing access and mobility management on the terminal device, for example, the first entity may be an AMF.

In some embodiments, the second entity may be a function or an entity for performing energy management on the terminal device, for example, the second entity may be an AIPMF.

In some embodiments, the communication device may further include a third entity, and the third entity is an entity configured to store ambient information. For example, the third entity may be an AF. In some embodiments, the ambient information may include weather information. The AF may be an application function or an application server of the meteorological department, and may provide weather information.

In some embodiments, the communication device may further include a fourth entity, and the fourth entity may be a function or an entity for performing network data analysis, for example, the fourth entity may be a NWDAF.

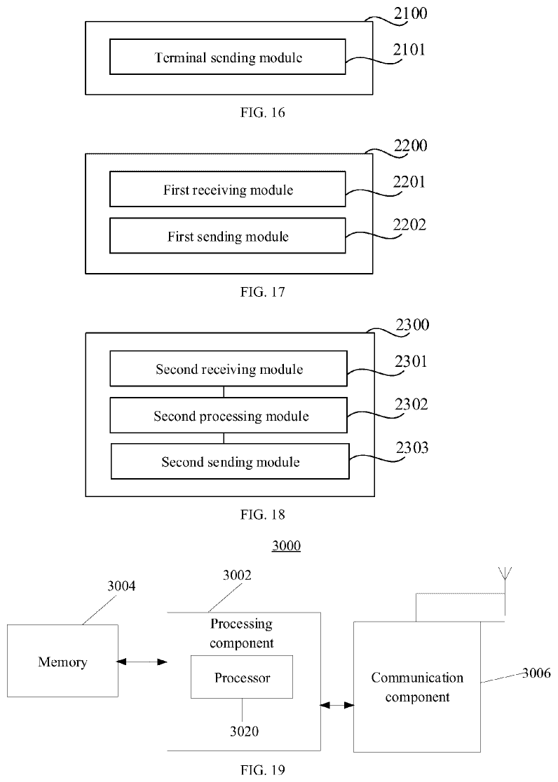

FIG. 16 is a block diagram of a communication apparatus 2100 shown according to some embodiments of the present disclosure. The communication apparatus may be applied in a terminal device. As shown in FIG. 16, the apparatus 2100 may include a terminal sending module 2101.

The terminal sending module 2101 is configured to send energy information related to energy of the terminal device, where the energy information is used to indicate a second entity to determine communication status information of the terminal device according to the energy information.

In some embodiments, the energy information includes a power source indication parameter and/or an energy status parameter of the terminal device.

In some embodiments, the terminal sending module 2101 is configured to send the energy information through a non-access stratum (NAS) message.

In some embodiments, the terminal sending module 2101 is configured to send the energy information to the second entity by using a first entity.

In some embodiments, the first entity is an access and mobility management function (AMF).

In some embodiments, the second entity is an ambient Internet of Things power management function (AIPMF).

FIG. 17 is a block diagram of a communication apparatus 2200 shown according to some embodiments of the present disclosure. The communication apparatus may be applied in a first entity. As shown in FIG. 17, the apparatus 2200 may include a first receiving module 2201 and a first sending module 2202.

The first receiving module 2201 is configured to receive energy information related to energy of a terminal device.

The first sending module 2202 is configured to send the energy information to a second entity.

In some embodiments, the energy information includes a power source indication parameter and/or an energy status parameter of the terminal device.

In some embodiments, the first receiving module 2201 is further configured to receive communication status information of the terminal device, where the communication status information is status information determined by the second entity according to the energy information.

In some embodiments, the first entity is an access and mobility management function (AMF), and the second entity is an ambient Internet of Things power management function (AIPMF).

FIG. 18 is a block diagram of a communication apparatus 2300 shown according to some embodiments of the present disclosure. The communication apparatus may be applied in a second entity. As shown in FIG. 18, the apparatus 2300 may include a second receiving module 2301, a second processing module 2302 and a second sending module 2303.

The second receiving module 2301 is configured to receive energy information related to energy of a terminal device.

The second processing module 2302 is configured to determine communication status information of the terminal device according to the energy information.

The second sending module 2303 is configured to send the communication status information.

In some embodiments, the energy information includes a power source indication parameter and/or an energy status parameter of the terminal device.

In some embodiments, the second processing module 2302 is configured to obtain ambient information, and determine communication status information of the terminal device according to the energy information and the ambient information.

In some embodiments, the second processing module 2302 is configured to send an ambient information request message to a third entity, and receive the ambient information sent by the third entity, where the third entity is a function or an entity configured to provide the ambient information.

In some embodiments, the second processing module 2302 is configured to determine the communication status information by performing data analysis according to the energy information and the ambient information.

In some embodiments, the second processing module 2302 is configured to: send an analysis request message to a fourth entity, where the analysis request message includes the energy information and the ambient information, and the fourth entity is a function or an entity that performs network data analysis; and receive an analysis response message sent by the fourth entity, where the analysis response message includes communication status information of the terminal device.

In some embodiments, the communication status information includes a target communication status parameter, and the target communication status parameter is used to indicate the communication status of the terminal device.

In some embodiments, the communication status information further includes a valid time parameter, and the valid time parameter is used to indicate a valid time range of the target communication status parameter.

In some embodiments, the second sending module 2303 is configured to send the communication status information to the first entity and/or the access network device.

In some embodiments, the first entity is an access and mobility management function (AMF).

In some embodiments, the second entity is an ambient Internet of Things power management function (AIPMF).

With regard to the apparatus in the above embodiments, the specific manner in which the various modules perform operations has been described in detail in the embodiments related to the method, which will not be described in detail here.

FIG. 19 is a block diagram of a communication apparatus shown according to some embodiments of the present disclosure. The communication apparatus 3000 may be a terminal device in the communication system shown in FIG. 1 or FIG. 2; or, the communication apparatus 3000 may be a first entity, a second entity, a third entity, or a fourth entity in the communication system shown in FIG. 2.

Referring to FIG. 19, the apparatus 3000 may include one or more of the following components: a processing component 3002, a memory 3004, and a communication component 3006.

The processing component 3002 may be configured to control overall operations of the apparatus 3000, such as operations associated with display, telephone calls, data communications, camera operations, and recording operations. The processing component 3002 may include one or more processors 3020 to execute instructions to complete all or part of the steps of the foregoing communication method. In addition, the processing component 3002 may include one or more modules which facilitate the interaction between the processing component 3002 and other components. For example, the processing component 3002 may include a multimedia module to facilitate interaction between the multimedia component and the processing component 3002.

The memory 3004 is configured to store various types of data to support the operations of the apparatus 3000. Examples of such data include instructions of any application or method operating on the apparatus 3000, contact data, phonebook data, messages, pictures, videos, etc. The memory 3004 may be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The communication component 3006 is configured to facilitate wired or wireless communication between the apparatus 3000 and other devices. The apparatus 3000 may access a wireless network based on a communication standard, such as Wi-Fi, 2G, 3G, 4G, 5G, 6G, NB-IoT, eMTC, or the like, or a combination of them. In some embodiments, the communication component 3006 receives a broadcast signal or broadcast related information from an external broadcast management system via a broadcast channel. In some embodiments, the communication component 3006 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In some embodiments, the apparatus 3000 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for performing the communication methods described above.

The apparatus 3000 may be an independent electronic device, or may be a part of an independent electronic device. For example, in an embodiment, the electronic device may be an integrated circuit (IC) or a chip, and the integrated circuit may be an IC or a set of more than one IC. The chip may include, but is not limited to, a Graphics Processing Unit (GPU), a Central Processing Unit (CPU), a Field Programmable Gate Array (FPGA), a Digital Signal Processor (DSP), an Application Specific Integrated Circuit (ASIC), a System on Chip (SOC), etc. The integrated circuit or chip may be configured to execute an executable instruction (or code) to implement the foregoing communication method. In some embodiments, the executable instruction may be stored in the integrated circuit or the chip, or may be obtained from another apparatus or device. For example, the integrated circuit or the chip includes a processor, a memory, and an interface for communication with another apparatus. The executable instruction may be stored in the processor, and when the executable instruction is executed by the processor, the foregoing communication method is implemented; or the integrated circuit or the chip may receive an executable instruction through an interface and transmit the executable instruction to the processor for execution, to implement the foregoing communication method.

In some embodiments, the present disclosure further provides a computer-readable storage medium, on which a computer program instruction is stored. When the program instruction is executed by a processor, the steps of the communication method provided in the present disclosure are implemented. For example, the computer-readable storage medium may be a non-transitory computer-readable storage medium including an instruction, for example, may be the memory 3004 including an instruction, and the instruction may be executed by the processor 3020 of the apparatus 3000 to complete the foregoing communication method. For example, the non-transitory computer-readable storage medium may be a ROM, a random access memory (RAM), a CD-ROM, a magnetic tape, a floppy disk, an optical data storage device, or the like.

In another example embodiment, there is further provided a computer program product including a computer program executable by a programmable apparatus. The computer program has a code portion for performing the communication method described above when executed by the programmable apparatus.

Other embodiments of the present disclosure will be apparent to those skilled in the art from consideration of the description and practice of the present disclosure. The present disclosure is intended to cover any variations, uses, or adaptations of the present disclosure. These variations, uses, or adaptations follow the general principles of the present disclosure and include common general knowledge and conventional technical means in the art not disclosed in the present disclosure. It is intended that the description and embodiments are considered as examples only, with a true scope and spirit of the present disclosure being indicated by the following claims.

It should be understood that the present disclosure is not limited to the precise structures that have been described above and shown in the accompanying drawings, and various modifications and changes may be made without departing from the scope of the present disclosure. The scope of the present disclosure is only limited by the appended claims.

1. A communication method, performed by a terminal device, and comprising:
sending energy information related to energy of the terminal device, wherein the energy information indicates a second entity to determine communication status information of the terminal device according to the energy information.

2. The method according to claim 1, wherein the energy information comprises at least one of a power source indication parameter of the terminal device or an energy status parameter of the terminal device.

3. The method according to claim 1, wherein sending the energy information related to the energy of the terminal device comprises:
sending the energy information by using a non-access stratum (NAS) message.

4. The method according to claim 1, wherein sending the energy information related to the energy of the terminal device comprises:
sending the energy information to the second entity by using a first entity;
wherein the first entity is an access and mobility management function (AMF), and the second entity is an ambient Internet of Things power management function (AIPMF).

5.-6. (canceled)

7. A communication method, performed by a second entity, and comprising:
receiving energy information related to energy of a terminal device;
determining communication status information of the terminal device according to the energy information; and
sending the communication status information.

8. The method according to claim 7, wherein the energy information comprises at least one of a power source indication parameter of the terminal device or an energy status parameter of the terminal device.

9. The method according to claim 7, wherein determining the communication status information of the terminal device according to the energy information comprises:
obtaining ambient information; and
determining the communication status information of the terminal device according to the energy information and the ambient information.

10. The method according to claim 9, wherein obtaining the ambient information comprises:
sending an ambient information request message to a third entity, wherein the third entity is a function or an entity for providing the ambient information; and
receiving the ambient information sent by the third entity.

11. The method according to claim 9, wherein determining the communication status information of the terminal device according to the energy information and the ambient information comprises:
determining the communication status information by performing data analysis according to the energy information and the ambient information.

12. The method according to claim 9, wherein determining the communication status information of the terminal device according to the energy information and the ambient information comprises:
sending an analysis request message to a fourth entity, wherein the analysis request message comprises the energy information and the ambient information, and the fourth entity is a function or an entity for performing network data analysis; and
receiving an analysis response message sent by the fourth entity, wherein the analysis response message comprises the communication status information of the terminal device.

13. The method according to claim 7, wherein the communication status information comprises at least one of:
a target communication status parameter, wherein the target communication status parameter indicates communication status of the terminal device; or
a valid time parameter, wherein the valid time parameter indicates a valid time range of the target communication status parameter.

14. (canceled)

15. The method according to claim 7, wherein sending the communication status information comprises:
sending the communication status information to at least one of a first entity or an access network device.

16. The method according to claim 15, wherein the second entity is an ambient Internet of Things power management function (AIPMF).

17. A communication method, performed by a communication device, wherein the communication device comprises a first entity and a second entity, and the method comprises:
receiving, by the first entity, energy information related to energy of a terminal device, and sending the energy information to the second entity; and
receiving, by the second entity, the energy information, and determining communication status information of the terminal device according to the energy information.

18. The method according to claim 17, wherein the communication device further comprises a third entity, the third entity is an entity for storing ambient information, and the method further comprises:
sending, by the second entity, an ambient information request message to the third entity, receiving the ambient information sent by the third entity, and determining the communication status information of the terminal device according to the energy information and the ambient information; and
sending, by the third entity, the ambient information to the second entity according to the received ambient information request message.

19. The method according to claim 18, wherein the communication device further comprises a fourth entity, the fourth entity is a functional entity for performing network data analysis, and the method further comprises:
sending, by the second entity, an analysis request message to the fourth entity, and receiving an analysis response message sent by the fourth entity, wherein the analysis request message comprises the energy information and the ambient information, and the analysis response message comprises the communication status information of the terminal device; and
receiving, by the fourth entity, the analysis request message, and determining the communication status information according to the energy information and the ambient information in the analysis request message.

20. The method according to claim 17, wherein the first entity is an access and mobility management function (AMF), and the second entity is an ambient Internet of Things power management function (AIPMF).

21.-23. (canceled)

24. A communication apparatus, comprising:
a processor; and
a memory, configured for storing an instruction executable by the processor;
wherein the processor is configured to perform steps of the method according to claim 1.

25. (canceled)

26. A communication apparatus, comprising:
a processor; and
a memory, configured for storing an instruction executable by the processor;
wherein the processor is configured to perform steps of the method according to claim 7.

27. A communication apparatus, comprising:
a processor; and
a memory, configured for storing an instruction executable by the processor;
wherein the processor is configured to perform steps of the method according to claim 17.
